(19) United States
(12) Patent Application Publication
(10) Pub. No.: US 2002/0178561 A1
(43) Pub. Date: Dec. 5, 2002

(54) Pipe sealing structure for forming thermal pipe

(76) Inventor: Meng Cheng Huang, Nan-Ron Load (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/193,921

(22) Filed: Jul. 15, 2002

Related U.S. Application Data
(63) Continuation-in-part of application No. 09/357,999, filed on Jul. 21, 1999.

(51) Int. Cl. B23P 23/04; B32B 1/08

(52) U.S. Cl. 29/33 R; 428/36.9

(57) ABSTRACT

A pipe sealing structure for forming a thermal pipe is formed by steps of performing a reduced cross sectional area less than the cross sectional area of the opening thereof to form an extended region, clamping a portion of the extruded region into a collapsed portion, cutting the outer end of the collapsed portion, and peforming a spot welding on the cut outer end of the collapsed portion. Furthermore, additional steps including selectively determining a predetermined length of the thermal pipe, forming a reduced size portion of the pipe at the predetermined length are added to the manufacturing procedure.

### BACKGROUND OF THE INVENTION

1. Field of tie Invention

The present invention relates to a pipe sealing structure, and more particularly, to a pipe sealing structure formed of steps of forming a collapsed portion of an extruded region at first, then cutting the outer end of the collapsed portion, and spot welding the cut outer end in the final step.

2. Description of the Prior Art

With reference to FIG. 1, a prior art thermal pipe is illustrated, Embodiment of the thermal pipe 10a in FIG. 1 is a round pipe having an opening at one end thereof and sealed at the other end, A tapered scaling portion 11a is formed in the opening of the thermal pipe 10a by punching incorporated with the tin glue or some kinds of adhesives. However, the width of the sealing portion is wider than the diameter of the thermal pipe, resulting in increasing the cost and difficulty of the thermal pipe assembly.

Please refer to FIG. 2 showing another prior art thermal pipe 12a Diameter of the opening of the thermal pipe 12a is reduced by the way of cooling, and then the reduced portion is pressed to form a flat sealing portion 13a. Front edge of the flat sealing portion 13a is then under the spot welding operation to complete the whole manufacturing procedure. However, this manufacturing procedure has following disadvantages: 1) The welding operation and the size of the welding machine have to be very precise; 2) The end product thereof can not be adjusted in size anymore; and 3) High manufacturing cost and low yield.

### SUMMARY OF THE INVENTION

Accordingly, the primary objective of the present invention is to provide a pipe sealing structure, wherein an extruded portion is formed by molding the opening of the pipe sealing structure to form an extruded region, the applying a pair of clamping members to the extruded region for the sake of forming a collapsed portion on the extruded region, cutting the outer end of the collapsed portion, and performing a spot welding on the cut outer end of the collapsed portion last Thereby, the present pipe sealing structure may have some tolerance for the spot welding precision and the manufacturing cost thereof can be lowered down dramatically. Further, the thermal pipe can be adjusted to any desired length.

The various objective and advantages of the present invention will be more readily understood from the following detailed description when read in conjunction with the appended drawings.

### BRIEF DESCRIPTION OF THE DRAWINGS

FIG. 1 is a schematic diagram of a pipe sealing structure according to the prior art.

FIG. 2 is a schematic diagram of illustrating another prior art pipe sealing structure.

FIGS. 3A through 3H are schematic diagrams of illustrating the manufacturing procedure for the present invention pipe sealing structure.

FIG. 4 is a schematic diagram for showing another embodiment of the present invention.

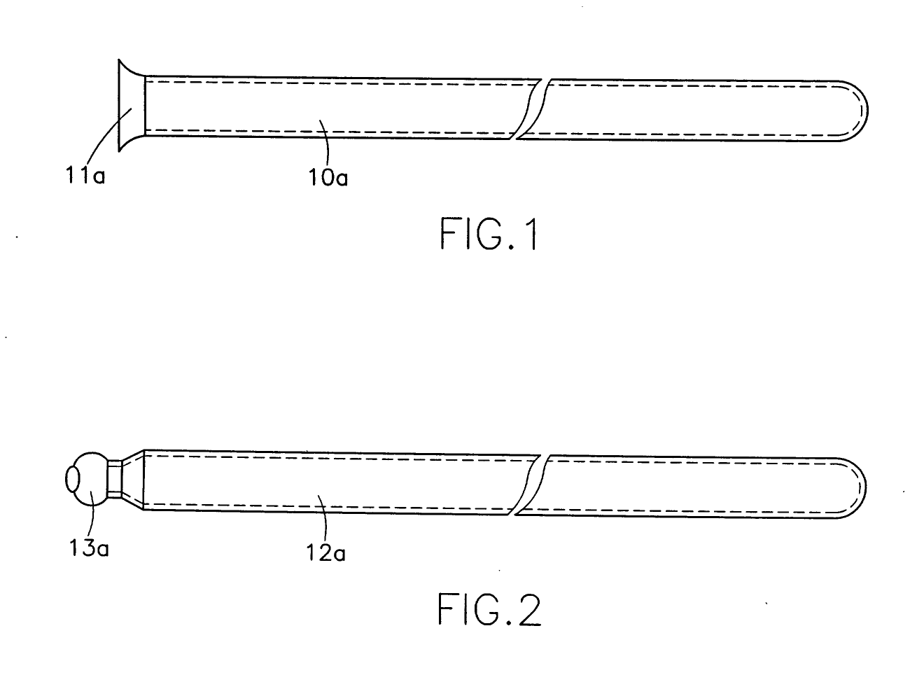

### DETAILED DESCRIPTION OF THE PREFERRED EMBODIMENT

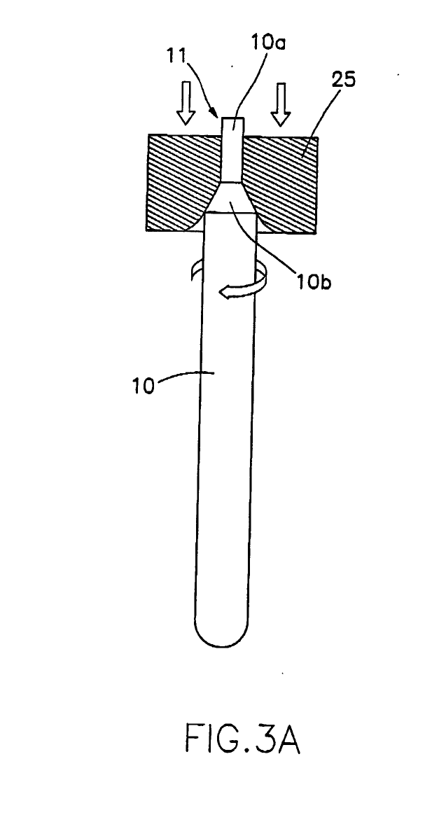

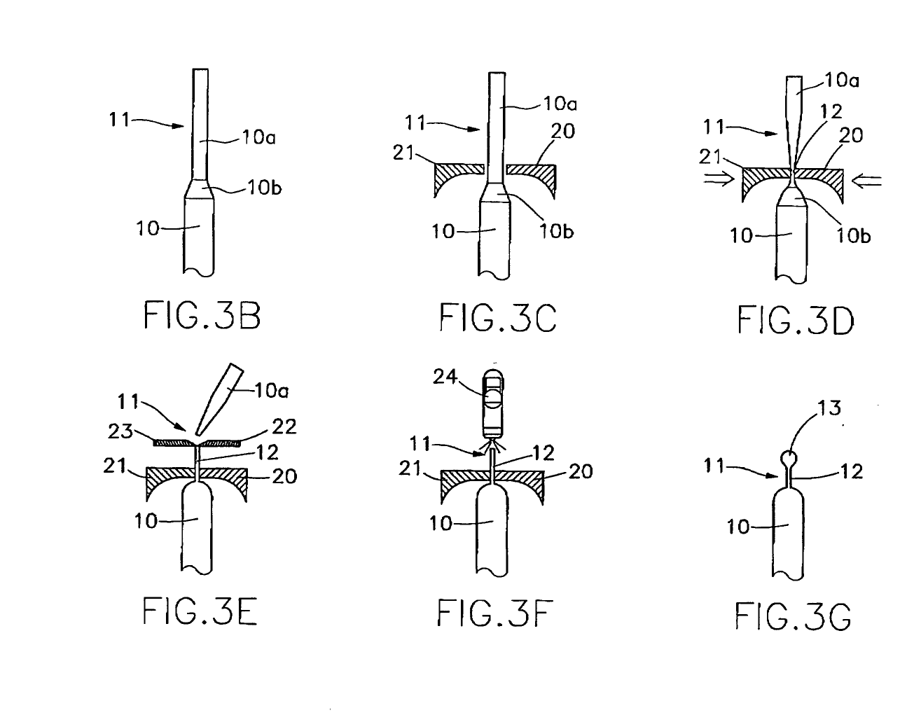

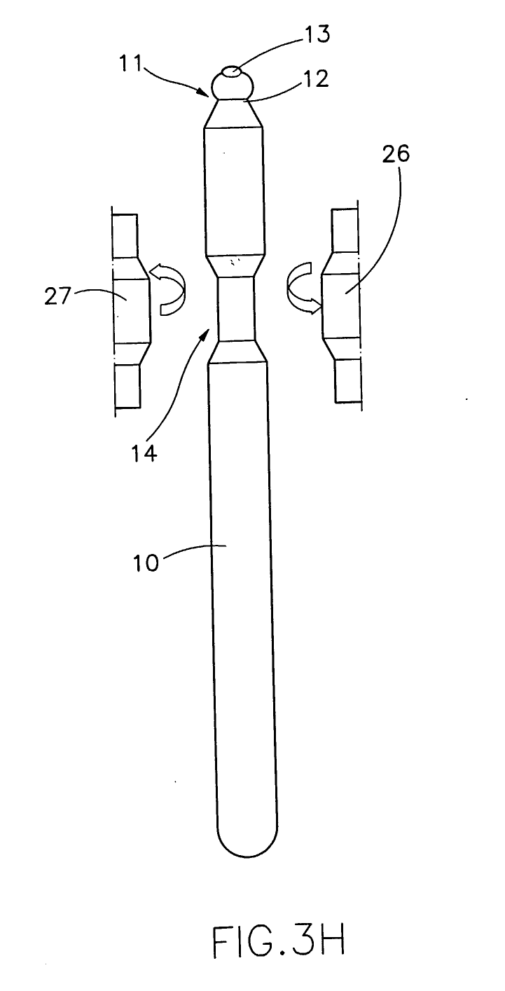

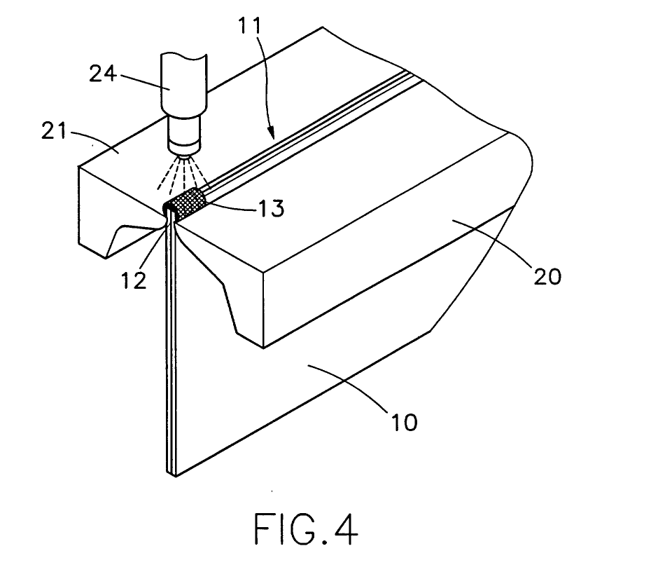

Please refer to FIGS. 3A through 3H, which disclose the manufacturing procedure for the pipe sealing structure according to the present invention. A thermal pipe 10 is a hollow cylinder, having an opening 11 on one end thereof and sealed on the other end. For the purpose of having a pipe sealing structure, following steps have to be performed. At first, a mold 25 with a reduced cross-sectional are which less than the pre-reduced cross-sectional area of the opening 11 serves to form an extruded region 10a having a reduced cross-sectional area. As shown in FIGS. 3A and 3B, the mold 25 creates a region 10b around the opening 11 having a reduced cross-sectional area and having an extruded region 10a. Then, a pair clamping members 20 and 21 are applied to clamp a portion of this extruded region 10a to form a collapsed portion 12, as shown as in FIGS. 3C and 3D. By the collapsed portion 12, the opening 11 of the thermal pipe 10 is retained in a sealing state, and a pair of cutting members 22 and 23 further cut the outer end of the collapsed portion 12, as shown as in FIG. 3E. The cut end of the collapsed portion 12 is further performed a spot welding operation by a spot welding machine 24 as shown in FIG. 3F. Thus, a welding portion 13 is formed so as to seal the thermal pipe 10, as shown as in FIG. 3G. In FIG. 3H, some additional manufacturing steps performed after the operation of spot welding are illustrated. These steps are selectively deter a predetermined length of the pipe sealing structure, forming a reduced size portion of the pipe sealing structure at the predetermined length by a pair of contacting rollers, and repeating aforementioned steps of forming the collapsed region, cutting the outer end, and performing a spot welding.

Besides, as shown in FIG. 4, the thermal pipe 10 of the present invention may be a flat shape hollow plate. Since We opening 11 of the thermal pipe 10 has a long rectangular shape, a movable spot welding machine 24 serves to perform the spot welding operation on the opening 11 so as to form a long welding portion 13. The pipe sealing structure of the present invention thus has following advantages:

1) No need to control the respective size, and the thermal pipe is with a uniform outlook;

2) Rapid manufacturing speed;

3) Simpler structure, lower cost, and capability of mass production;

4) With any desired length for the thermal pipe;

5) A variety of spot welding machines applicable to this manufacturing procedure;

6) Reduced cross sectional area for the opening thereof without interrupting other assembling components; and

7) Both ends of the thermal pipe applicable to this procedure.

In comparison with prior arts, the present invention requires no precise spot welding operation and the respective size of spot welding, and tie thermal pipe can be with the capability of mass production and lower manufacturing cost.

Although the present invention has been described with reference to the preferred embodiment, it will be understood that the invention is not limited to the details described thereof. Various situations and modifications have been suggested in the foregoing description, and others occur to those of ordinary skill in the art. Therefore, all such substitutions and modifications are intended to be embraced within the scope of the invention as defined in the appended claims.

What is claimed is:

1. A pipe sealing structure formed by the steps of:
(a) reducing the size of an opening of the pipe through use of a mold having a cross-sectional area less than a pre-reduced cross-sectional area of said opening, said mold forming an extruded region of said pipe having a reduced cross-sectional area;
(b) forming a collapsed portion of the size reduced opening to seal the opening of the pipe by clamping a portion of the size reduced opening between a pair of clamping members;
(c) cutting an outer end of the collapsed portion with a pair of cutting members; and
(d) spot welding the cut end of the collapsed portion to thereby complete the sealing structure of the pipe.

2. The pipe sealing structure of claim 1 wherein the step of spot welding is followed by the steps of:
(e) selectively determining a predetermined length of said pipe subsequent to step (d);
(f) forming a reduced size portion of said pipe at said predetermined length by a pair of contacting rollers; and
(g) repeating steps (b) through (d) for providing said predetermined length of said pipe.
